(19) United States
(12) Patent Application Publication
(10) Pub. No.: US 2016/0144716 A1
(43) Pub. Date: May 26, 2016

(54) INTEGRATED CONTROLLER SYSTEM AND METHOD FOR CONTROLLING THE SAME

(71) Applicant: HYUNDAI MOTOR COMPANY, Seoul (KR)

(72) Inventor: Sung Un KIM, Yongin-si (KR)

(21) Appl. No.: 14/853,998

(22) Filed: Sep. 14, 2015

(30) Foreign Application Priority Data
Nov. 25, 2014 (KR) 10-2014-0165449

(51) Int. Cl. B60K 35/00; G06F 3/0489; G06F 3/0487; G06F 3/0362

(52) U.S. Cl. CPC B60K 35/00; G06F 3/0362; G06F 3/0489; G06F 3/0487; B60K 2350/102; B60K 2350/1024; B60K 2350/908

(57) ABSTRACT

An integrated controller system includes an information processor configured to display driving information on a display. A rotary knob includes an upper plate button having a plurality of buttons arranged thereon for operating the information processor and a cylindrical body for rotating by a user's hand in a dial mode. A rotation detecting sensor is connected to the rotary knob for detecting the amount of rotation. A controller is configured to set a function selection of the plurality of buttons to match with user interface (UI) frame arrangement according to the UI frame arrangement displayed on the display.

### CROSS-REFERENCE TO RELATED APPLICATION

This application claims the benefit of priority to Korean Patent Application No. 10-2014-0165449 filed in the Korean Intellectual Property Office on Nov. 25, 2014, the entire content of which is incorporated herein by reference.

### TECHNICAL FIELD

The present disclosure relates to an integrated controller system for a vehicle and a method for controlling the same.

### BACKGROUND

A vehicle includes buttons, knobs, and devices using a voice recognition function and an integrated controller system therein for controlling vehicle information.

Further, an advanced driver assistance system (ADAS) and other equipment for convenience have been added thereto for user convenience, and thus, the number of devices in the vehicle has been increased. However, due to complicacy of the controller system, a driver's attention is distracted for finding a controller system during driving. Vehicle manufacturers have been widely applying the integrated controller system to the vehicle to enable integrated control of different functions of the vehicle.

The vehicle integrated controller system of the related art includes a mouse system, a rotary system, and so on, which can secure the driver from driving.

However, since the mouse system uses touch screen system user interface (UI), the driver is required to stare at a screen while moving a cursor to a desired point on the UI, so that attention of the driver is dispersed, and since the controlling system has a high degree of freedom, accurate positioning of the cursor is not easy while driving.

Further, in a case of the mist widely used rotary system which can move up/down and/or can rotate, only sequential movement is possible on the UI, and thus, stepwise frequent control is required to move from a low rank menu to a high rank menu or from the high rank menu to the low rank menu. That is, since the rotary system several steps to make a selection, selection of a low rank function is difficult and a controlling time period is extensive.

FIG. 1 illustrates an integrated controller system of a related art.

Referring to FIG. 1, in the related art, shortcut buttons are arranged around the integrated controller system for improving accessibility to functions used frequently such as navigation, radio, and so on. However, since the provided shortcut buttons are limited to button functions for selecting particular main functions, such as navigation, audio, and air conditioning, they have a significant shortage in reduction of items/menus within the UI, and movement of a hand holding the integrated controller system for selection of the button is large.

The above information disclosed in this Background section is only for enhancement of understanding of the background of the disclosure, and therefore, it may contain information that does not form the prior art that is already known in this country to a person of ordinary skill in the art.

### SUMMARY

The present disclosure has been made in an effort to provide an integrated controller system and a method for controlling the same having advantages of making direct access to a target menu.

An aspect of the present inventive concept provides an integrated controller system which makes smooth movement between a high rank menu and a low rank menu or between the high rank menu, a middle rank menu, and the low rank menu to access a target menu directly by omitting an intermediate step, and a method for controlling the same.

According to an exemplary embodiment of the present inventive concept, an integrated controller system in a vehicle includes an information processor configured to display driving information on a display. A rotary knob includes an upper plate button having a plurality of buttons arranged thereon for operating the information processor and a cylindrical body for rotating by a user's hand in a dial mode. A rotation detecting sensor is connected to the rotary knob for detecting the amount of rotation. A controller is configured to set a function selection of the plurality of buttons to match with a user interface (UI) frame arrangement according to the UI frame arrangement displayed on the display.

When the cylindrical body rotates, the upper plate is stationary to maintain the arrangement of the upper plate button.

The rotation detecting sensor may be any one of a variable resistor, an encoder, and a magnetic field sensor or a Hall effect sensor.

The controller may group the plurality of buttons to identically match the function selection with the UI frame arrangement.

The controller may group a plurality of adjacent buttons in a horizontal direction or a vertical direction.

When the displayed UI frame arrangement is changed, the upper plate button may be set again to match with the changed UI frame arrangement.

The information processor may display a high rank menu UI frame and at least one stepwise low rank menu UI frame related to the high rank menu selected with the rotary knob on the display.

The rotary knob may select and control a target menu directly without having an intermediate step between the high rank menu UI frame and the low rank menu UI frame by using the upper plate button.

The direct selection may include the direct selection of the low rank menu from the high rank menu in a forward direction without passing through a middle rank menu, and of the high rank menu from the low rank menu without passing through the middle rank menu in a backward direction.

According to another exemplary embodiment of the present inventive concept, a method for controlling an integrated controller system which includes an information processor configured to display driving information on a display, and a vehicle integrated controller configured to control the information processor includes: a) selecting a first function and push control on the vehicle integrated controller including an upper plate button having a plurality of buttons arranged thereon for controlling the information processor and a cylindrical body for rotating by a user's hand in a dial mode; b) displaying a high rank menu UI frame related to the first function and at least one stepwise low rank menu UI frame at a time on the display; c) setting a function selection of the plurality of buttons to match with a UI frame arrangement according to the UI frame arrangement displayed on the display; and d) directly selecting and controlling a target menu without passing through an intermediate step by using the upper plate button.

The step b) may include displaying low rank menu frames when previously used stepwise low rank menus are related to the first function. The at least one stepwise low rank menu UI frame includes at least one selection menu.

The step c) may include grouping the plurality of buttons to identically match a function selection structure with the UI frame arrangement.

The method, after the step d), may further include e) directly selecting a high rank menu UI frame without passing through the intermediate step by using the upper plate button for controlling a target high rank menu of a second function.

The step e) may include displaying the high rank menu related to the second function and at least one stepwise low rank UI frame on the display. If the displayed UI frame arrangement is changed, the upper plate button is set again to match with the changed UI frame arrangement.

According to the integrated controller system in a vehicle of the exemplary embodiment of the present inventive concept, since the plurality of steps of UI frames displayed on one screen may be directly selected and accessed, inconvenience of use resulting from sequential control can be reduced, and particularly, the dispersion of attention which is important during driving may be minimized.

The integrated controller system in a vehicle has an advantage of permitting quick and convenient access to a UI in different UI states, such as direct access from the high rank menu to the low rank menu, direct access from the low rank menu to the high rank menu, and so on.

Further, since modes of the upper plate button matched with the UI frame structure displayed on the display are consistent, safe control is possible without looking at the buttons while driving.

In addition, by arranging the UI frame direct access button on the upper plate of the rotary knob and controlling the UI frame only with the knob, the shortcut button and the up/down and left/right control functions mounted around the related art integrated controller system may be omitted, and thus, production cost may be reduced.

### BRIEF DESCRIPTION OF THE DRAWINGS

FIG. 1 illustrates a block diagram of a related art integrated controller system.

FIG. 2 schematically illustrates a block diagram of an integrated controller system in a vehicle in accordance with an exemplary embodiment of the present inventive concept.

FIG. 3 schematically illustrates a perspective view of an integrated controller system in accordance with an exemplary embodiment of the present inventive concept.

FIGS. 4 and 5 respectively illustrate exemplary upper plate buttons matched to a UI frame structure in accordance with an exemplary embodiment of the present inventive concept.

FIGS. 6(A)-6(C) illustrate exemplary settings of an upper plate button varied with a structure of a UI frame arrangement in accordance with an exemplary embodiment of the present inventive concept.

FIG. 7 schematically illustrates a flowchart showing the steps of a method for controlling an integrated controller system in a vehicle in accordance with an exemplary embodiment of the present inventive concept.

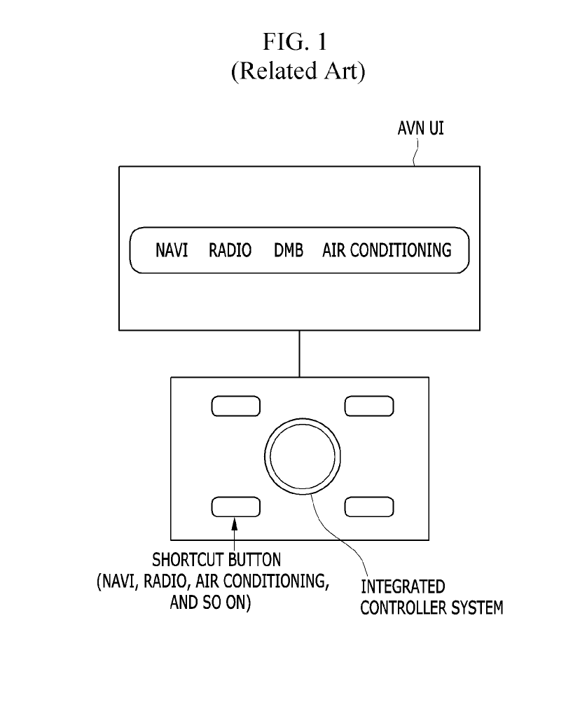

### DETAILED DESCRIPTION OF THE EMBODIMENTS

The present disclosure will be described more fully hereinafter with reference to the accompanying drawings, such that persons in this field of art can easily carry it out. However, the present disclosure may be embodied in different modes, and is not limited to the description of embodiments made herein. Parts not relevant to the present disclosure will be omitted for describing the present disclosure clearly, and throughout the specification, identical or similar parts will be given the same reference numbers.

Throughout the specification, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation, and can be implemented by hardware components or software components and combinations thereof.

An integrated controller system and a method for controlling the same in accordance with an exemplary embodiment of the present inventive concept will now be described in detail with reference to the drawings.

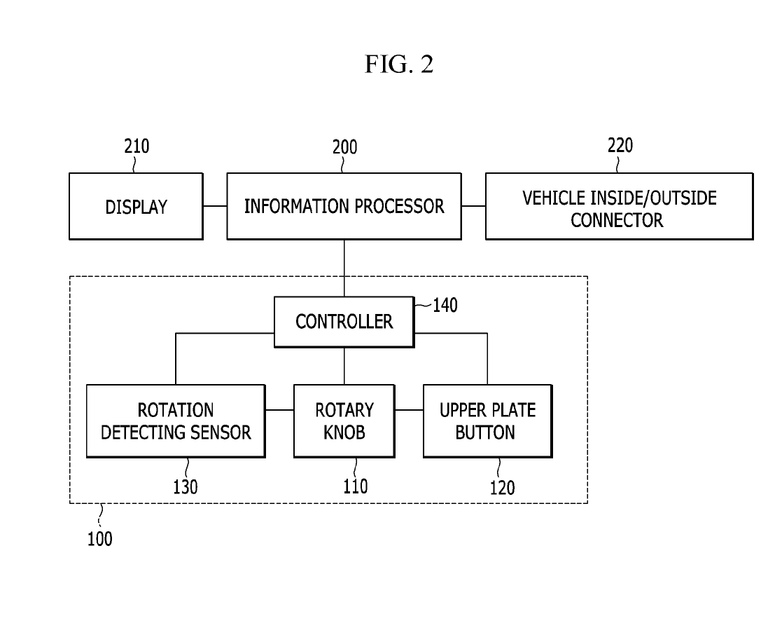

FIG. 2 illustrates a block diagram of an integrated controller system in a vehicle in accordance with an exemplary embodiment of the present inventive concept, schematically.

Referring to FIG. 2, the integrated controller system in a vehicle in accordance with an exemplary embodiment of the present inventive concept includes a vehicle integrated controller 100, and an information processor 200 for running different functions of the vehicle by controlling the integrated controller 100.

The integrated controller 100 has a rotary knob 110 and an upper plate button 120 for central integrated control of information devices in the vehicle. The integrated controller 100 is electrically connected to the information processor 200 which is connected to a display 210 and a vehicle inside and outside connector 220.

The display 210 may include at least one of a display module provided to a cluster area of the vehicle and a display module displayed on a center fascia area.

The vehicle inside and outside connector 220 includes an inside interface connected to different controllers, such as an air conditioner controller, an engine controller, and so on in the vehicle, and an outside interface for transmission and reception of information to/from external communication networks through a USB or a wireless communication module provided in the vehicle. As an example, the outside interface may transmit and receive data to and from the external information device by using a wireless communication network, such as telematics and a WiFi repeater.

The information processor 200 may be an audio visual navigation (AVN) system for processing information regarding operation of the vehicle.

However, the information processor 200 in accordance with the exemplary embodiment of the present inventive concept is not limited to the AVN system, but may be an information processing device having an air conditioning system and different electronic convenience systems in the vehicle integrated thereto.

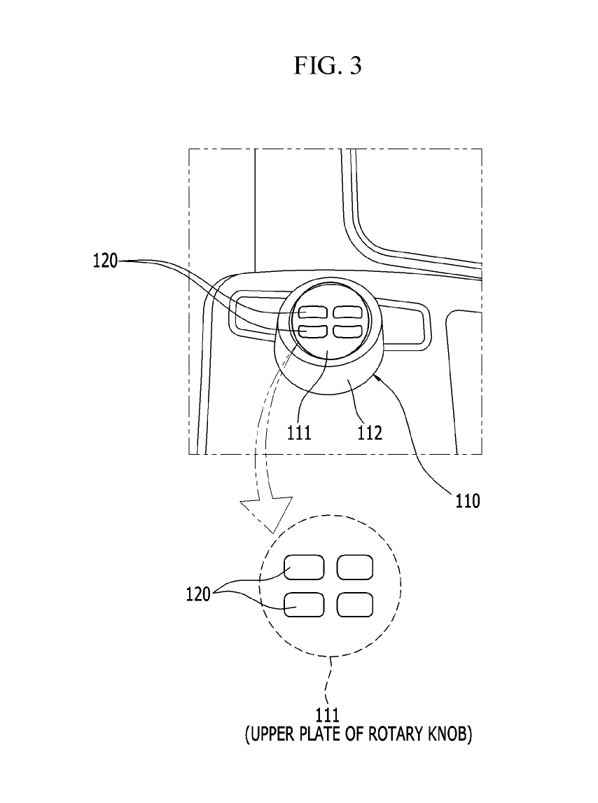

FIG. 3 schematically illustrates a perspective view of an integrated controller system in accordance with an exemplary embodiment of the present inventive concept.

Referring to FIG. 3, the integrated controller 100 in accordance with an exemplary embodiment of the present inventive concept is mounted near a gear shifter, and includes the rotary knob 110, the upper plate button 120, a rotation detecting sensor 130, and a controller 140.

The rotary knob 110 includes an upper plate 111 for arranging the upper plate button 120 thereon, and a cylindrical body 112 for a user to hold with a hand while rotating the body 112 in a dial mode.

When the cylindrical body 112 rotates, the upper plate 111 is stationary to not change an arrangement structure of the upper plate button 120.

The rotary knob 110 enables direction control in up/down or left/right directions and push control for changing an inside parameter after selection of a user interface (UI) frame, of which detailed description will be omitted because the rotary knob 110 is a known art.

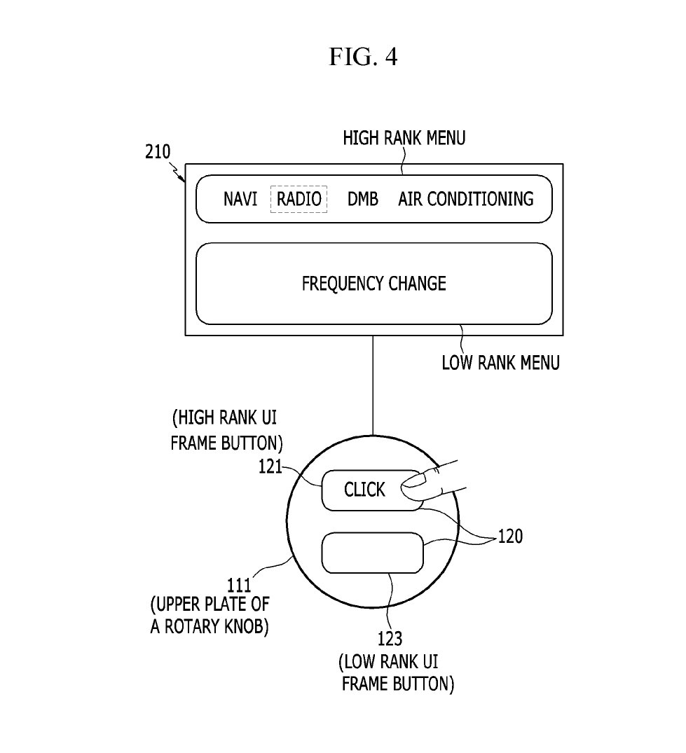

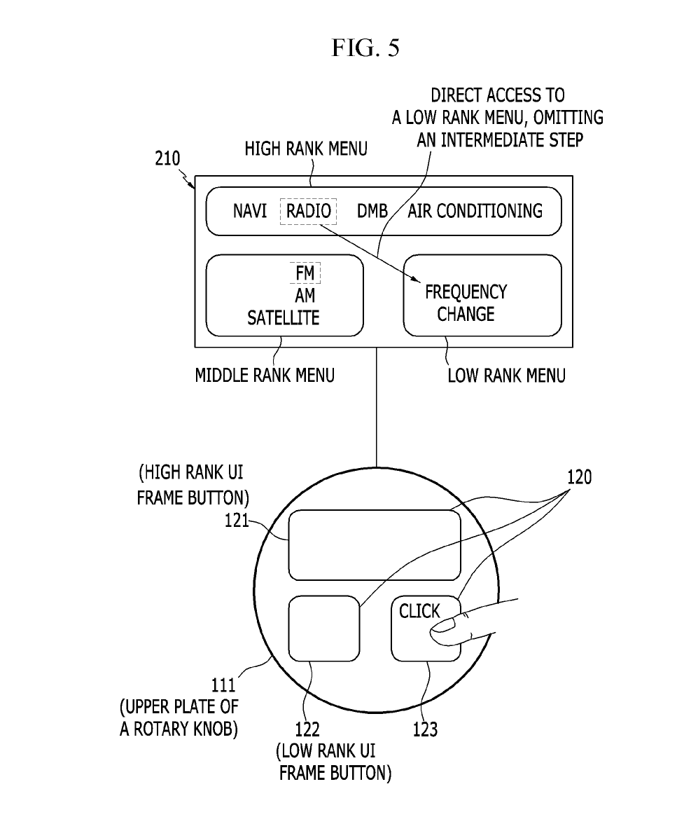

FIGS. 4 and 5 illustrate upper plate buttons matched to a UI frame structure in accordance with an exemplary embodiment of the present invention.

In general, the information processor 200 has the UI frame with a depth of a high rank, a middle rank, a low rank, or a rank deeper than the depth on each of functions the information processor 200 handles. In this case, the UI frame is a frame for displaying at least one menu which a user may select and run a function on the display 210 in the information processor 200.

Depending on a main function of the information processor 200, the information processor 200 may display a UI frame having high rank and low rank menus, or the high rank, middle rank, and low rand menus. In this case, function menus provide service functions of the navigation, radio, DMB, telephone, air conditioning, and so on provided to the vehicle.

Referring to FIGS. 4 and 5, in order to improve accessibility within all of the UI menus that the information processor 200 handles, the information processor 200 may display the UI frame of the high rank menu and the low rank menu on one screen at a time, or the UI frame of the high rank menu, the middle rank menu, and the low rank menu on one screen.

The upper plate button 120 includes a plurality of buttons arranged on the upper plate 111 of the rotary knob 110. The plurality of buttons have a function selection structure in which the plurality of buttons are matched to the plurality of UI frame structures displayed on the display 210.

For example, referring to FIG. 4, according to the UI frame structure of the high rank menu displayed on an upper side of the display 210 and the low rank menu displayed on a lower side of the display 210, the upper plate button 120 may have a high rank UI frame button 121 and a low rank UI frame button 123 arranged on an upper side and a lower side thereof, respectively.

Further, according to the UI frame structure of the high rank menu displayed on the upper side of the display 210 as shown in FIG. 5, the middle rank menu displayed on a left side of the lower side of the display 210, and the low rank menu displayed on a right side of the lower side of the display 210, the upper plate button 120 may have the high rank UI frame button 121 arranged on the upper side, and the middle rank UI frame button 122 and the low rank UI frame button 123 arranged on a left side and a right side of the lower side, respectively.

In this case, if the upper plate button 120 selects a radio function of the high rank by using a high rank UI frame button 121, the information processor 200 displays a middle rank menu and a low rank menu related to the radio function on one screen at a time. In addition, if FM in a selected state at the middle rank UI frame matches with a control target of the user, the upper plate button 120 selects the low UI frame button 123 to directly access the low rank menu without performing an intermediate control step.

Thus, the low rank menu is directly accessible from the high rank menu in a forward direction without passing through the middle rank menu, and the high rank menu is directly accessible from the low rank menu without passing through the middle rank menu in a backward direction.

The rotation detecting sensor 130 is connected to a shaft of the rotary knob 110 for detecting the amount of rotation, and may include a variable resistor, an encoder, and a magnetic field sensor (Hall effect sensor).

The rotation detecting sensor 130 senses the rotation of the rotary knob 110 preciously. In this case, a smallest rotation sensing angle may be sensed by the rotation detecting sensor 130, which is a moving unit for selection of a menu (item).

The controller 140 sets the plurality of buttons of the upper plate button 120 to have a control structure matched to the UI frame structure with reference to a structure of the UI frame arrangement displayed on the information processor 200. In this case, the controller 140 may group the plurality of buttons to have a function selection structure that is matched to the structure of the UI frame arrangement.

The controller 140 may group a plurality of adjacent buttons in a horizontal direction or a vertical direction to match with the structure of the UI frame arrangement, and if the UI frame arrangement displayed is changed, the controller 140 sets the structure of the upper plate button unit 120 again to match the changed structure.

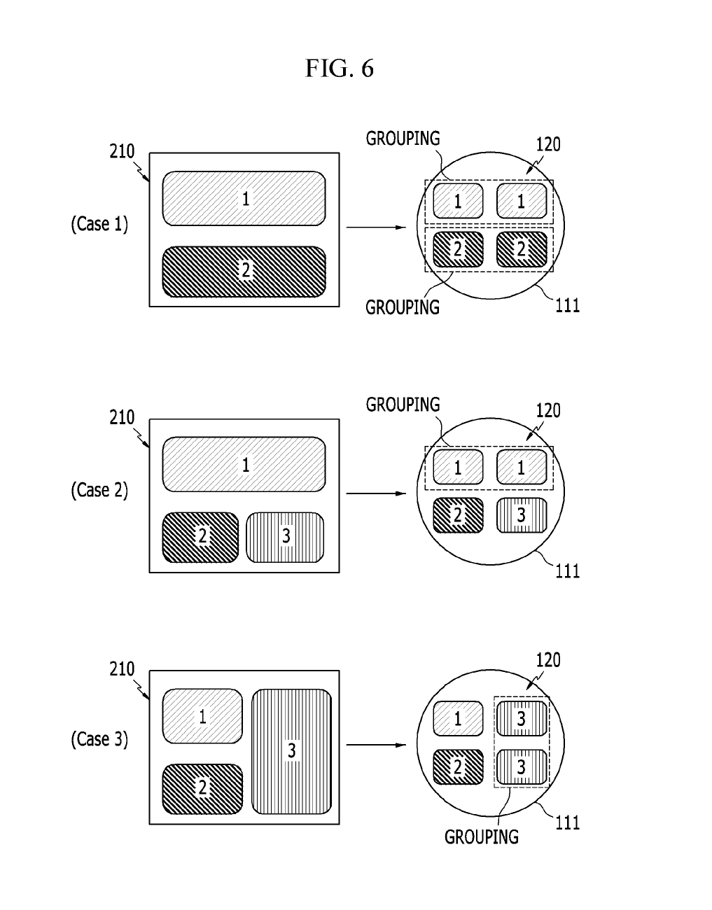

FIGS. 6(A)-6(C) illustrate exemplary settings of an upper plate button varied with a structure of a UI frame arrangement in accordance with an exemplary embodiment of the present inventive concept.

Hereinafter, the specification will be described assuming that the buttons arranged on the upper plate button 120 are four with two arranged on the upper side and two arranged on the lower side for convenience, however, the number of buttons is not limited.

First, FIG. 6(A) shows a state in which a first UI frame 1 is arranged on the upper side of the display 210 and a second UI frame 2 is displayed on the lower side of the display 210.

The controller 140 sets the buttons arranged on the upper plate button 120 so that the buttons are divided to upper side buttons and lower side buttons in order to match with the UI frame structure. In this case, the controller 140 may group the four buttons into the two upper side buttons and the two lower side buttons.

Therefore, even if the user selects one of the two buttons grouped on the upper side, the user may control the first UI frame 1 displayed on the display 210. Likewise, even if the user selects one of the two buttons grouped on the lower side, the user may control the second UI frame 2 displayed on the display 210. For reference, such button setting of the case 1 may be substantially the same as that of the button structure in FIG. 4.

Next, FIG. 6(B) shows one first UI frame 1 arranged on the upper side of the display 210, and a second UI frame 2 and a third UI frame 3 arranged on the lower side of the display 210 side by side.

In order to match the button control structure with the UI frame structure, the controller 140 sets the two buttons on the upper side of the upper plate button 120 to control the first UI frame 1 by grouping the two buttons on the upper side of the upper plate button 120, and sets the buttons on the left side and the right side of the lower side of the upper plate button 120 to control the second UI frame 2 and the third UI frame 3, respectively. The button setting in the case 2 is substantially the same as the button structure in FIG. 5.

In FIG. 6(C), the first UI frame 1 and the second UI frame 2 are arranged on an upper side and a lower side of a left side of the display 210, and the third UI frame 3 is arranged on the upper side and the lower side of the right side of the display 210.

In order to match the button control structure with the UI frame structure, the controller 140 sets the two buttons on the upper side and the lower side of the left side of the upper plate button 120 to control the first UI frame 1 and the second UI frame 2, respectively. Further, the controller 140 sets the two buttons on the upper side and the lower side of the right side of the upper plate button 120 as one group in a vertical direction to control the third UI frame.

Thus, the controller 140 may set the buttons to control different UI frames displayed on the display 210 at positions matched to the positions of the buttons for the user to control the different UI frames displayed on the display 210 by controlling the buttons at identical positions to those of a target UI frame the user intends to control, enabling the user to control the buttons of a relevant function freely without dispersion of attention, while only looking at the UI frame on the screen while controlling the upper plate button 120.

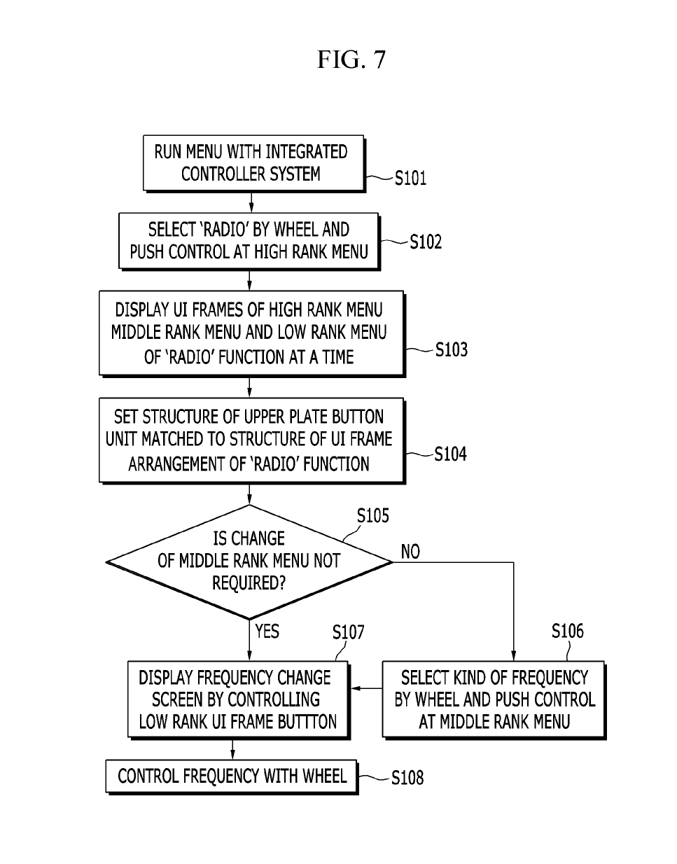

A method for controlling an integrated controller system in a vehicle in accordance with an exemplary embodiment of the present inventive concept will now be described with reference to FIG. 7.

FIG. 7 schematically illustrates a flowchart showing steps of a method for controlling an integrated controller system in a vehicle in accordance with an exemplary embodiment of the present inventive concept.

Referring to FIG. 7, the integrated controller system 100 according to the present disclosure performs a main menu function with a push button of the rotary knob 110 (S101).

If the integrated controller system 100 selects a radio function and push control (S102) from a high rank menu, UI frames of a middle rank menu and a low rank menu are displayed on the display 110 together with the high rank menu related to the radio function (S103).

In this case, the display 110 may display the UI frames while the middle rank menu and the low rank menu used previously related to the radio function that are selected in advance. Since menus used previously may likely be used again, the user may skip an intermediate step required for selecting a low rank target menu by displaying the previously used menus in advance. As an example, in a case of the radio, if an FM frequency is the last selection, by displaying the middle rank menu in a state that the FM is selected, the selection may be omitted.

The integrated controller system 100 sets a structure of the upper plate button 120 with reference to, and matched to, the structure of the UI frame arrangement of the radio function on the display 110 (S104). Since description has been made with respect to this using FIG. 6, a detailed description will be omitted.

If the integrated controller system 100 is not required to change the menu (as an example, FM) selected presently from the middle rank UI frame menus of the “radio function” (S106; Yes), the integrated controller system 100 omits a middle rank UI frame menu selection step, and displays a frequency change frame by controlling the low rank UI frame button (S107).

The integrated controller system 100 selects a radio frequency the user desires by controlling the frequency with the wheel (S108).

If a change of the middle rank menu is required in the step S105 (S106; No), the integrated controller system 100 may select kinds of frequency (as an example, AM) with wheel and push control at the middle rank menu (S106), and may control the frequency with the wheel (S108).

Thus, according to the integrated controller system in a vehicle in accordance with the present disclosure, since the plurality of steps of UI frames displayed on one screen may be selected and accessed directly, a reduction in inconvenience of use resulting from sequential control, and particularly, a minimization of the dispersion of attention which is important during driving, may occur.

Further, the integrated controller system in accordance with the present disclosure has an advantage of permitting quick and convenient access to a UI in different UI states, such as direct access from the high rank menu to the low rank menu, direct access from the low rank menu to the high rank menu, and so on.

Moreover, different from the shortcut buttons, since modes of the upper plate button of the vehicle integrated controller system matched to the UI frame structure displayed on the display are consistent, safe control is possible without looking at the buttons while driving.

Further, by arranging the UI frame direct access button on the upper plate of the rotary knob and controlling the UI frame only with the knob, omitting the shortcut button and the up/down and left/right control functions mounted around the related art integrated controller system, production cost may be reduced.

The exemplary embodiment of the present inventive concept may be realized not only with the system and/or method, but also with a program corresponding to the present disclosure, and with a medium having the program written thereon, and such embodiments may be easily embodied by a person skilled in this field of art from the embodiment described thereof.

What is claimed is:

1. An integrated controller system comprising:
an information processor configured to display driving information of a vehicle on a display;
a rotary knob including an upper plate button having a plurality of buttons arranged thereon for operating the information processor and a cylindrical body rotating by a user's hand in a dial mode;
a rotation detecting sensor connected to the rotary knob and configured to detect the amount of rotation; and
a controller configured to set a function selection of the plurality of buttons to match with a user interface (UI) frame arrangement according to the UI frame arrangement displayed on the display.

2. The system of claim 1, wherein when the cylindrical body rotates, the upper plate is stationary to maintain the arrangement of the upper plate button.

3. The system of claim 1, wherein the rotation detecting sensor is any one of a variable resistor, an encoder, and a magnetic field sensor or a Hall effect sensor.

4. The system of claim 1, wherein the controller groups the plurality of buttons to identically match the function selection with the UI frame arrangement.

5. The system of claim 4, wherein the controller groups a plurality of adjacent buttons in a horizontal direction or a vertical direction.

6. The system of claim 1, wherein when the UI displayed frame arrangement is changed, the upper plate button is set again to match with the changed UI frame arrangement.

7. The system of claim 1, wherein the information processor displays a high rank menu UI frame and at least one stepwise low rank menu UI frame related to the high rank menu selected with the rotary knob on the display.

8. The system of claim 1, wherein the rotary knob selects and directly controls a target menu without an intermediate step between the high rank menu UI frame and the low rank menu UI frame by using the upper plate button.

9. The system of claim 8, wherein the direct selection includes the direct selection of the low rank menu from the high rank menu in a forward direction without passing through a middle rank menu, and of the high rank menu from the low rank menu without passing through the middle rank menu in a backward direction.

10. A method for controlling an integrated controller system which includes an information processor for displaying information on operation of a vehicle on a display, and a vehicle integrated controller for controlling the information processor, the method comprising steps of:
a) selecting a first function and push control on the vehicle integrated controller which includes an upper plate button having a plurality of buttons arranged thereon for controlling the information processor and a cylindrical body for rotating by a user's hand in a dial mode;
b) displaying a high rank menu UI frame related to the first function and at least one stepwise low rank menu UI frame on the display;
c) setting a function selection of the plurality of buttons to match with a UI frame arrangement according to the UI frame arrangement displayed on the display; and
d) directly selecting and controlling a target menu without passing through an intermediate step by using the upper plate button.

11. The method of claim 10, wherein the step b) includes displaying low rank menu frames when previously used stepwise low rank menus relate to the first function, and
wherein the at least one stepwise low rank menu UI frame includes at least one selection menu.

12. The method of claim 10, wherein the step c) includes grouping the plurality of buttons to identically match the function selection with the UI frame arrangement.

13. The method of claim 10, after the step d), further comprising e) directly selecting the high rank menu UI frame without passing through the intermediate step by using the upper plate button for controlling a target high rank menu of a second function.

14. The method of claim 13, wherein the step e) includes displaying the high rank menu related to the second function and at least one stepwise low rank UI frame on the display, and when the displayed UI frame arrangement changes, the upper plate button is set again to match with the changed UI frame arrangement.
